(19) United States
(12) Patent Application Publication
(10) Pub. No.: US 2005/0283409 A1
(43) Pub. Date: Dec. 22, 2005

(54) Method of substantiating web pages

(76) Inventor: Fang-Kun Cheng, Tainan (TW)

Correspondence Address: Fang-Kun Cheng, 7F., No. 213. Civic Boulevard. Sec. 4, Taipei, 105, TW

(21) Appl. No.: 10/871,416

(22) Filed: Jun. 18, 2004

(51) Int. Cl. G06F 17/60

(52) U.S. Cl. 705/27; 705/26

(57) ABSTRACT

Disclosed is a method of substantiating web pages, which acquires the advantages of E-commerce and on-line games to construct web pages with 3-dimensional visual effects that would attract customers' attention, such that customers are able to conveniently perform real-life conduct over web pages.

### FIELD OF INVENTION

This invention relates to a method of substantiating web pages, particularly to one acquiring the advantages of E-commerce and on-line games to construct web pages with 3-dimensional visual effects, such that customers are able to conveniently perform real-life conduct over web pages.

### BACKGROUND

With the developments of computer-related technology, E-commerce adopting networks has been the trend of the commercial industry. Generally speaking, E-commerce refers to modem commercial transactions that can quickly respond to the demands of the business or the customers, so as to reduce the operation cost and to improve the service quality.

Taking the B2C (business to customer) mode as an example, the highly efficient and interactive characteristics of computer allows the business to conduct on-line advertisement, on-line order and on-line customer services over the networks, while allowing the customers to browse the commodities and services provided by individual business for making price comparison and transactions.

Currently, E-commerce requires the business to set up an on-line shop or to participate in an on-line shopping district over the networks. Through the PC provided at the customer end, the customer is able to examine various commodities, review specification, or even test samples. Some businesses would even provide simple on-line network games or set up three-dimensional web pages to increase the browsing rate of the website. However, the currently available system is generally not user-friendly or thoroughly integrated. From the customer's point of view, though the customer is able to browse the catalogs of a certain shop over the internet, there are insufficient lists or catalogs for guiding the customer to visit a certain shop. The lacking of integration places burdens over the customer, who needs to spend time and cost to search for the desired shop or on-line information. Furthermore, some system can only provide information while failing to allow the customer to place an order. Even though some system allows the customer to select the “purchase” button that would initiate the payment authorization, such that the bank account of the on-line shop is able to subsequently collect the payment according to the designated approach, such system that is currently adopted in the E-commerce applications cannot provide instant vocal services or on-line dialogues when the customer would like to acquire additional information with respect to the commodities shown in the catalog, or to perform discussions or price negotiations. In addition, when the customer encounters problems in operation, the business is unaware of such situations so as to provide instantaneous assistance or explanations. Though the customer is able to send a message expressing the problems to the on-line shop through an e-mail, it is unlikely that the on-line shop is able to comprehend the real problems encountered by the customer based on a simple message, so as to result in inappropriate responses. Communications via e-mails are also time-consuming.

As for the business's point of view, the ultimate goal of the business is to attract customers to visit the shop. Customers may be generally categorized in two groups, one that has selected the desired commodities prior to the actual purchases, the other that is aimless and would only purchase the commodities upon encountering the desired commodities.

For the first group of customers, prices or after-sell services offered by the shop would help the business to score a success. For the later group of customers, the shop needs to offer a variety of commodities or to join the other shops forming a shopping plaza to attract the customers. In E-commerce, when the first group of customers has entered the designation of the desired commodities, all shops that offer the desired commodities would appear on the browser to be browsed by the customers. However, some customers may only browse a shop's web page without actually proceeding with a transaction for reasons stated above, resulting in loss of business. Since the later group of customers has not even decided upon which commodities to purchase, and only intends to browse the uncovered web pages, the business's web page would not be able to attract the customers to a designated shop, let alone final transactions.

In view of the shortcomings founding the conventional E-commerce, this invention provides a method of substantiating web pages, which acquires the advantages of E-commerce and on-line games to construct web pages with 3-dimensional visual effects that would attract customers' attention, such that customers are able to conveniently perform real-life conduct over web pages.

### SUMMARY OF INVENTION

It is thus a primary objective of this invention to provide a method of substantiating web pages, which acquires the advantages of E-commerce and on-line games to construct web pages with 3-dimensional visual effects, such that customers are able to conveniently perform real-life conduct over web pages.

To achieve the above objective, this invention is realized by:

A method of substantiating web pages, comprising the steps of:

providing a web page with 3-dimensional visual effects to be browsed by a user; and

constructing an exclusive architecture with 3-dimensional visual effects by the user at a specific region of the web page.

As such, the invention is able to attract the customers' attention and allows the customers to conveniently perform real-life conduct over web page.

### BRIEF DESCRIPTION OF THE DRAWINGS

These and other modifications and advantages will become even more apparent from the following detailed description of a preferred embodiment of the invention and from the drawings in which:

FIG. 1 is a browsing map according to this invention.

FIG. 2 is a drawing illustrating the design of a web page according to this invention.

FIG. 3 is a flow chart illustrating an embodiment of this invention.

FIG. 4 is a flow chart illustrating an alternative embodiment of this invention.

### DETAILED DESCRIPTION OF THE INVENTION (PREFERRED EMBODIMENTS)

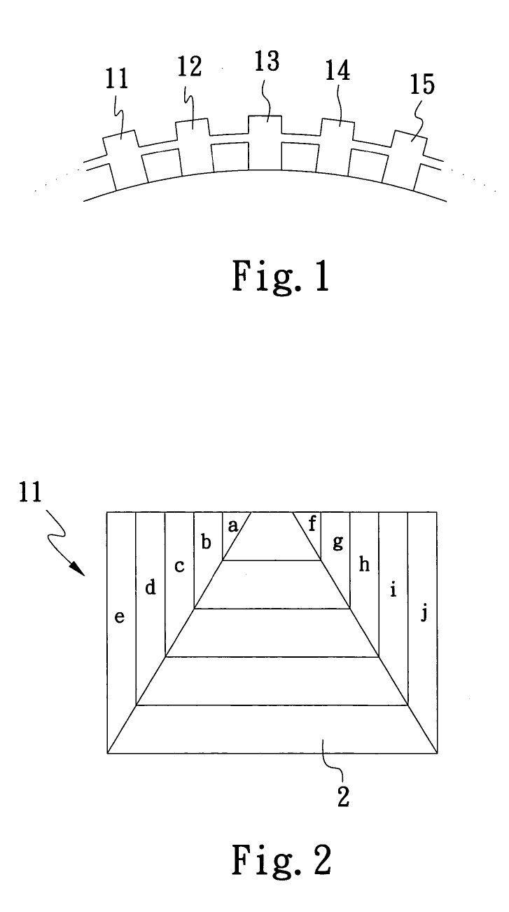

First referring to FIGS. 1 and 2, where FIG. 1 is a browsing map according to this invention and FIG. 2 is a drawing illustrating the design of a web page according to this invention.

This invention discloses a method of substantiating web pages, where each nation is represented by a closed region that includes plural portal home pages 11, 12, 13, 14, 15 for accessing the closed region. The number of the portal home pages may be unlimited, and each portal may be designated a residential district portal, a shopping district portal, a industrial district portal, a community portal or a city portal to assist the customers in entering the portal for browsing purpose. In each of the portal home pages 11-16 includes a web page with 3-dimensional visual effects. A shop may construct exclusive architectures with 3-dimensional visual effects at specific areas, a, b, c, d, e, f, g, h, i, j of the web page in the portal home page.

Furthermore, the business is able to design the appearance of the architectures. The web pages with 3-dimensional visual effects may be web pages having 3-dimensional streets 2 that intersect each other, or shops for providing customers with on-line consultations.

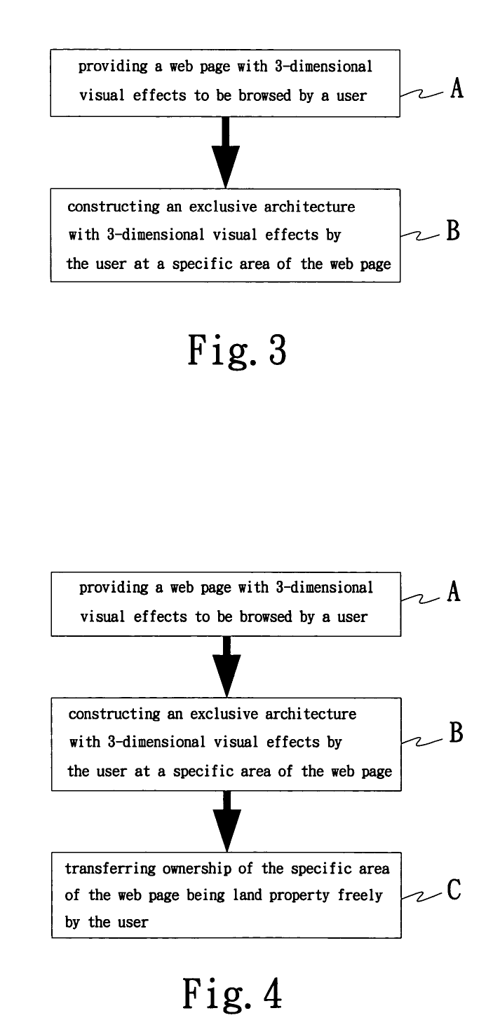

FIG. 3 is a flow chart illustrating an embodiment of this invention.

The method of substantiating web pages of this invention comprises the steps of: (A) providing a web page with 3-dimensional visual effects to be browsed by a user; and (B) constructing an exclusive architecture with 3-dimensional visual effects by the user at a specific area of the web page.

The user is able to design the appearance of the architectures, where the architectures may be shops for providing customers with on-line consultations. The web page with 3-dimensional visual effects may be a web page having 3-dimensional streets 2 that intersect each other, or shops for providing customers with on-line consultations.

FIG. 4 is a flow chart illustrating an alternative embodiment of this invention.

The method of substantiating web pages of this invention comprises the steps of: (A) providing a web page with 3-dimensional visual effects to be browsed by a user; (B) constructing an exclusive architecture with 3-dimensional visual effects by the user at a specific area of the web page; and (C) transferring ownership of the specific area of the web page being land property freely by the user.

The user is able to design the appearance of the architectures, where the architectures may be shops for providing customers with on-line consultations. The web page with 3-dimensional visual effects may be a web page having 3-dimensional streets 2 that intersect each other, or shops for providing customers with on-line consultations.

The web pages of this invention offer the customers the perception of shopping in a shopping district while browsing the web pages so as to induce the costumers' desires for purchases. The shops may also freely modify the landscape of the virtual land property, alter the appearance of the architectures, or form a family, an organization or a nation with others, simulating a virtual society to substantiate web pages. When a customer is interested in a certain commodity, the customer may obtain on-line and interactive consultations with the shop personnel. When a customer becomes aware that a land property or a shop is on sale during the browsing process, the customer may purchase the land property or the shop to set up a business. This invention overcomes the shortcoming that the on-line games can only serve recreational purposes without the possibility of substantiating the real-life.

Since the map in this invention is designed to be a closed region that is divided into virtual societies in terms of nations, such as Taiwan, Japan, USA, or Canada, that are connected by passageways, this invention constructs a virtual global society.

The method of substantiating web pages of this invention can indeed overcome the shortcomings of the conventional E-commerce and thus meets all patentability requirements stipulated by the Law.

The present invention has been described with a preferred embodiment thereof and it is understood that the scope and the spirit of the invention as defined by the appended claims.

1. A method of substantiating web pages, comprising the steps of:
providing a web page with 3-dimensional visual effects to be browsed by a user; and
constructing an exclusive architecture with 3-dimensional visual effects by the user at a specific area of the web page.

2. The method of substantiating web pages of claim 1, wherein the user is able to design appearance of the architecture.

3. The method of substantiating web pages of claim 1, wherein the architecture is a shop.

4. The method of substantiating web pages of claim 1, wherein the web page with 3-dimensional visual effects is a web page having 3-dimensional streets.

5. The method of substantiating web pages of claim 3, wherein the shop is able to provide a customer with on-line consultations.

6. The method of substantiating web pages of claim 4, wherein the streets intersect each other.

7. A method of substantiating web pages, comprising the steps of:
providing a web page with 3-dimensional visual effects to be browsed by a user;
constructing an exclusive architecture with 3-dimensional visual effects by the user at a specific area of the web page; and
transferring ownership of the specific area of the web page being land property freely by the user.

8. The method of substantiating web pages of claim 7, wherein the user is able to design appearance of the architecture.

9. The method of substantiating web pages of claim 7, wherein the architecture is a shop.

10. The method of substantiating web pages of claim 7, wherein the web page with 3-dimensional visual effects is a web page having 3-dimensional streets.

11. The method of substantiating web pages of claim 9, wherein the shop is able to provide a customer with on-line consultations.

12. The method of substantiating web pages of claim 10, wherein the streets intersect each other.
